(19) United States
(12) Patent Application Publication
(10) Pub. No.: US 2014/0323605 A1
(43) Pub. Date: Oct. 30, 2014

(54) STABLE EMULSIONS AND THEIR USE IN THE PRODUCTION OF FOAMS BASED ON ISOCYANATE

(71) Applicants: Reinhard Albers, Leverkusen (DE); Torsten Heinemann, Leichlingen (DE); Stephanie Vogel, Langenfeld (DE); Hartmut Nefzger, Puiheim (DE); Frank Otto, Hilden (DE)

(72) Inventors: Reinhard Albers, Leverkusen (DE); Torsten Heinemann, Leichlingen (DE); Stephanie Vogel, Langenfeld (DE); Hartmut Nefzger, Puiheim (DE); Frank Otto, Hilden (DE)

(73) Assignee: Bayer Intellectual Property GmbH, Monheim (DE)

(21) Appl. No.: 14/240,770

(22) PCT Filed: Aug. 22, 2012
(86) PCT No.: PCT/EP2012/066333

§ 371 Date: Jun. 9, 2014

(30) Foreign Application Priority Data
Aug. 26, 2011 (DE) 10 2011 081 622.4
Feb. 14, 2012 (EP) 12155277.2

(51) Int. Cl. C08G 18/48; C08L 75/08

(52) U.S. Cl. CPC C08G 18/48; C08L 75/08
USPC 521/128; 521/176; 521/131

(57) ABSTRACT

The invention relates to stable emulsions for the production of foams based on isocyanate, at least comprising three polyols A1a, A1b and A1c as well as at least one physical blowing agent T, wherein A1a is a polyether polyol obtained by addition of epoxides to starter compounds selected from carbohydrates and di- or higher-functional alcohols, A1b is a polyether polyol started on an aromatic amine, and A1c is a polyester polyol obtained by esterification of a polycarboxylic acid component and a polyalcohol component, wherein the total amount of aromatic dicarboxylic acid derivatives used in the esterification, calculated on the basis of the free aromatic dicarboxylic acids and based on the total mass of polyalcohol component and polycarboxylic acid component, is less than or equal to 48.5% by mass.

The invention relates to stable emulsions for the production of foams based on isocyanate, at least comprising three polyols A1a, A1b and A1c as well as at least one physical blowing agent T, wherein A1a is a polyether polyol obtained by addition of epoxides to starter compounds selected from carbohydrates and di- or higher-functional alcohols, A1b is a polyether polyol started on an aromatic amine, and A1c is a polyester polyol obtained by esterification of a polycarboxylic acid component and a polyalcohol component, wherein the total amount of aromatic dicarboxylic acid derivatives used in the esterification, calculated on the basis of the free aromatic dicarboxylic acids and based on the total mass of polyalcohol component and polycarboxylic acid component, is less than or equal to 48.5% by mass.

It is known that, in the production of foams from an isocyanate component and an isocyanate-reactive component containing polyol(s) using a physical blowing agent, an advantageous effect on the insulating action of the foam to be produced is obtained if the physical blowing agent is emulsified in the form of fine droplets in the isocyanate-reactive composition. The reason for this positive effect on the insulating action of the foam to be produced is that the droplets of the emulsion that are formed represent nucleation seeds for the subsequent foaming operation. The more droplets that exist, and the finer those droplets are, the more cells, and especially smaller cells, are contained in the later foam. This fact has a direct influence on the insulating properties of the foam so obtained because those properties are all the better, the smaller the foam cells that are formed. The difficulty in the preparation and processing of such emulsions is, however, their stability. The stability is defined by the non-separation of the polyol component and the physical blowing agent on simple storage of such an emulsion under normal conditions for a period of from several hours to several days without additional external stresses and even under stress caused by temperature influences and pressure increase and the influences of shear forces. Of technical relevance are, therefore, only those emulsions which possess such stability at least under normal conditions, preferably also under conditions in which temperature change, pressure increase and/or shear forces play a role. These ripening processes are generally countered by drastically increasing the viscosity and even doubling the viscosity of the liquid polyol phase. However, because the processing of emulsions is already made difficult by their non-Newtonian behaviour, excessive viscosity increases are undesirable. Emulsions can be referred to as being storage-stable only if the emulsions remain stable for at least several days without separating. Such storage-stable emulsions are particularly important for industrial processing. In addition to the above-mentioned ripening processes, phase separation mechanisms at the same time take place in emulsions with inadequate stability. These have the result that the strongly non-polar physical blowing agent separates from the comparatively highly polar polyol formulation over time and floats. However, phase separation leads to largely unusable foam results and must therefore definitely be avoided.

EP 0 905 160 A1 describes storage-stable blowing agent-containing emulsions for the production of rigid foams based on isocyanate (see paragraph [0001]), by concomitant use of polyether alcohols having a functionality of greater than 1.5 and a hydroxyl number of from 10 to 100 mg KOH/g as reactive emulsion stabilisers (see paragraph [0014]) in the polyol component. The emulsions contain polyether alcohols which are prepared by addition of lower alkylene oxides, preferably ethylene oxide and/or propylene oxide, to OH- and/or NH-functional starter substances, for example sugar alcohols and aromatic amines (see paragraph [0025]). There are preferably added to the polyether alcohols also polyester alcohols, which are prepared from polyfunctional carboxylic acids and polyfunctional alcohols (see paragraph [0026]). The blowing agent is emulsified in the polyol mixture, and a storage-stable emulsion is obtained (see paragraph [0021]). However, it is also possible for the blowing agent to be added to the polyol mixture in the mixing head or just before the mixing head. However, the specific combination of the three polyols A1a, A1b and A1c is not disclosed in this specification.

US 2002/0169228 A1claims a phase-stable polyol mixture comprising a propylene oxide polyether polyol co-started with sucrose and dipropylene, a polyester polyol and a hydrocarbon having from 4 to 6 carbon atoms as blowing agent, which is phase-stable for at least 24 hours (see claim 1). It is additionally possible to add to the mixture a polypropylene oxide polyether polyol started with toluenediamine and having an OH functionality of from 3.5 to 4.5 (see paragraph [0020]). The polyester polyol is started with phthalic anhydride (see claim 3) and is preferably STEPANPOL 2352, which is based on phthalic anhydride and diethylene glycol (see paragraph [0022]). Cyclopentane can be used as the blowing agent (see paragraph [0029]), which is either present in the form of a microemulsion in the polymer mixture (see paragraph [0006]), is added to the polyol mixture just before the mixing head, or is fed to the mixing head as a separate stream (see paragraph [0027]). The polyol mixture is reacted with an organic polyisocyanate to give a polyurethane foam (see claim 17). The term “microemulsion” within the scope of this application means that the blowing agent is present in dissolved form in the polyol mixture; see paragraph [0006]. This is also clear in paragraph [0013], where it is disclosed that the polyol mixture is no longer deemed to be phase-stable if it has a cloudy appearance. The statement that the polyol composition must remain phase-stable for at least 24 hours (see paragraph [0006]) indicates that the term “microemulsion” is used incorrectly in this application. A true microemulsion is in the state of a thermodynamic minimum and therefore has unlimited stability, as long as the composition and temperature do not change. Unlike such microemulsions, emulsions are sensitive especially to temperature but also to shock. Heating and then cooling them to the starting temperature generally leads to an irreversible change in the disperse structure, which can result in breakdown of the emulsion. Maintaining the stability of a “true” emulsion, as in the present invention, is therefore considerably more difficult than in the case of “microemulsions”.

Consequently, application US 2002/0169228 A1 refers to the solution of the blowing agent in the polyol mixture. According to this specification, all factors that impair the solubility of the blowing agent are to be avoided, for which reason only propylene oxide is used in the preparation of the polyether polyols (see paragraph [0018]).

WO 00/24813 A1 describes the production of rigid polyurethane foams for the thermal insulation of, for example, refrigerators (page 1, lines 3 to 5). The foams consist of organic polyisocyanates, a polyol mixture comprising polyether and/or polyester polyols, a blowing agent and further auxiliary substances and additives (see claim 1). The blowing agent comprising cyclopentane and water is dispersed in the polyol mixture (see claim 1). The polyether polyols are prepared by addition polymerisation of a polyhydroxy alcohol on polyethylene oxide and/or propylene oxide (page 4, lines 11 to 15) and preferably have from 3 to 6 OH groups (page 5, lines 13 to 15). Glycerol, sorbitol, sucrose and aromatic amines, for example, can be used as polyhydroxy alcohols (page 5, lines 1 to 3 and 6 to 7). The polyester polyol can be prepared from dicarboxylic acid anhydrides (e.g. phthalic anhydride) and diols (e.g. diethylene glycol) (page 5, lines 16 to 31) and preferably has 2 functional groups (page 6, lines 4 to 6). Polyether polyols started on aromatic amines are disclosed in this specification in the comparison examples (“Polyol K”). In these comparison examples, the pentane is dissolved and not emulsified in the polyol component (see Table 1 on p. 13). The content of Polyol K is relatively high at 40% (Comparison Example 1) and 50% (Comparison Example 2), based on all the polyols present in a particular case.

None of the documents of the prior art mentioned above discloses an isocyanate-reactive composition in which a physical blowing agent T is so dispersed in a mixture of the polyols A1a, A1b and A1c mentioned at the beginning that a storage-stable emulsion (which is to be distinguished from both a solution and a microemulsion) is obtained, without the viscosity of the isocyanate-reactive composition being increased too greatly as compared with conventional, completely dissolved isocyanate-reactive compositions.

Taking account of the above, the present invention provides an emulsion comprising
(I) an isocyanate-reactive composition A, comprising a polyol mixture A1 of at least three polyols A1a, A1b and A1c, as the continuous phase

and
(II) at least one, preferably exactly one, physical blowing agent T as the disperse phase,

wherein:
(i) A1a is a polyether polyol having a hydroxyl number of from 15 mg KOH/g to 550 mg KOH/g, preferably from 50 mg KOH/g to 500 mg KOH/g, particularly preferably from 100 mg KOH/g to 450 mg KOH/g, and having a functionality of from 1.5 to 6.0, preferably from 2.0 to 5.5, particularly preferably from 2.5 to 5.0, obtained by addition of an epoxide to one or more starter compound(s) selected from the group consisting of carbohydrates and di- or higher-functional alcohols, preferably di- or higher-functional alcohols having vicinal hydroxyl groups;
(ii) A1b is a polyether polyol having a hydroxyl number of from 100 mg KOH/g to 550 mg KOH/g, preferably from 200 mg KOH/g to 500 mg KOH/g, particularly preferably from 350 mg KOH/g to 470 mg KOH/g, and having a functionality of from 1.5 to 5.0, preferably from 2.0 to 4.5, particularly preferably from 2.5 to 4.0, obtained by addition of an epoxide to an aromatic amine;
(iii) A1c is a polyester polyol having a hydroxyl number of from 100 mg KOH/g to 450 mg KOH/g, preferably from 150 mg KOH/g to 400 mg KOH/g, particularly preferably from 200 mg KOH/g to 400 mg KOH/g, and having a functionality of from 1.5 to 3.5, preferably from 1.5 to 3.0, particularly preferably from 1.8 to 2.8, obtained by esterification of a polycarboxylic acid component and a polyalcohol component, wherein the total amount of aromatic dicarboxylic acid derivatives used in the esterification, calculated on the basis of the free aromatic dicarboxylic acids, is less than or equal to 48.5% by mass and preferably from 10.0% by mass to 48.5% by mass, particularly preferably from 20.0% by mass to 47.0% by mass, most particularly preferably from 20.0% by mass to 46.0% by mass, and extremely most particularly preferably from 35.0% by mass to 46.0% by mass, in each case based on the total mass of polyalcohol component and polycarboxylic acid component.

Within the scope of this application, the use of the word “one” in connection with components according to the invention, such as, for example, particular polyols, is not to be understood as being a numeral. Expressions such as “one polyol” or the like therefore mean “exactly one (=1) polyol” only when this is expressly stated. It is, for example, conceivable for two polyols of type A1a to be present.

Within the context of the present invention, an “emulsion” is understood as being a finely divided mixture of two liquids, in which one liquid (namely the physical blowing agent T) is dispersed in the other liquid (namely the polyol mixture A1) in the form of fine droplets showing an average size ≧0.1 μm to ≦20 μm, the droplet size being determined by using an optical microscope operating in bright field transmission mode. Such an emulsion is different both from a true solution and from a microemulsion. Microemulsions possess such a finely divided disperse phase that no light refraction occurs. Such microemulsions therefore appear clear and transparent in the visible light range, whereas emulsions within the scope of the present invention appear cloudy and exhibit strong light refraction. Also, microemulsions can be prepared only with the aid of emulsifying aids, while the use of emulsifying aids, although not ruled out in principle in the preparation of the emulsions according to the invention, is not absolutely necessary and is therefore not preferred. According to this invention, the droplet size of the blowing agent T is preferably ≧0.1 μm to ≦15 μm and more preferred ≧1 μm to ≦15 μm. The size is determined via an optical microscope using bright field transmission microscopy. Suitable layer thicknesses for the optical inspection of the specimen are 20 μm to 40 μm.

Within the context of the present invention, “physical blowing agents” are understood as being compounds that, on account of their physical properties, are readily volatile and do not react with the isocyanate component.

The “hydroxyl number” indicates the amount of potassium hydroxide in milligrams which is equivalent to the amount of acetic acid bonded by one gram of substance in an acetylation. It is determined within the context of the present invention according to standard DIN 53240, version of December 1971.

Within the context of the present invention, “functionality” denotes the theoretical functionality calculated from the known materials used and their relative proportions.

The expression “dicarboxylic acid derivative” includes the dicarboxylic acids themselves and all compounds known to the person skilled in the art that are derived from dicarboxylic acids, that is to say carboxylate salts, carboxylic acid anhydrides, carboxylic acid esters and carboxylic acid halides. The two functional groups of an aromatic dicarboxylic acid derivative can also be different.

The “total amount of aromatic dicarboxylic acid derivatives” refers to the total amount by mass of aromatic dicarboxylic acid derivatives used for the preparation of a polyester polyol A1c, based on the total mass of polyalcohol component and polycarboxylic acid component, the free aromatic dicarboxylic acids forming the basis of calculation irrespective of which aromatic dicarboxylic acid derivative is actually used. In preferred embodiments, only phthalic acid derivatives are used as aromatic dicarboxylic acid derivatives in the preparation of A1c (see below for details).

The present invention further provides a process for the production of a polyurethane-containing polymer C, in which an isocyanate component B is reacted with an emulsion according to the invention.

A “polyurethane-containing polymer C” is understood as being both polymers that contain solely polyurethane groups (PUR groups) and polymers that additionally contain urea and/or polyisocyanurate groups (PIR groups).

The present invention further provides the polyurethane polymers C so obtainable and their use for insulation purposes.

Surprisingly, it has been found that, by means of the combination according to the invention of the polyols A1a, A1b and A1c, the total viscosity of the isocyanate-reactive composition, and accordingly also the total viscosity of the emulsion, is under certain circumstances not only not disadvantageously increased as compared with isocyanate-reactive compositions (polyol mixtures) of the prior art that form a solution with the physical blowing agent, but can even be lowered. In particular, it has been found that the total amount of aromatic dicarboxylic acid derivatives used in the preparation of the polyester polyol A1c is of great importance for the stability of the emulsions.

This and other circumstances are described below by means of various embodiments and examples of the present invention, it being possible for the individual embodiments to be freely combined with one another, provided that the opposite is not clearly evident from the context.

The preparation of the polyols A1a to A1c (and optionally further polyols; see below) which can be used according to the invention is known in principle to the person skilled in the art and has already been described many times. Polyester polyols are obtained by polycondensation of dicarboxylic acid equivalents and low molecular weight polyols. Polyether polyols are obtained by polyaddition (anionic or cationic) of epoxides to suitable starter compounds. The addition of epoxides to polyester polyols yields the polyester polyether polyols according to the invention. If necessary, the polymerisation reactions are carried out in the presence of suitable catalysts known to the person skilled in the art.

In preferred embodiments, the polyether polyol A1a is started on sucrose, mixtures of sucrose and propylene glycol, mixtures of sucrose and ethylene glycol, mixtures of sucrose, propylene glycol and ethylene glycol, sorbitol or mixtures of sorbitol and glycerol. Preferred epoxides are 1,2-butylene oxide, 2,3-butylene oxide, ethylene oxide and propylene oxide, individually or in mixtures. Particular preference is given to ethylene oxide and propylene oxide, which can be used individually or both together, wherein in the latter case both a random distribution of the oxyalkylene units derived from the ethylene oxide and the propylene oxide and the purposive preparation of block copolymers having a specific structure is conceivable. Particularly preferred as starters are mixtures of sucrose, propylene glycol and ethylene glycol. Particularly preferably, propylene oxide is used on its own as the epoxide. Particularly preferably, the hydroxyl number of A1a is from 100 mg KOH/g to 450 mg KOH/g and the functionality is from 2.5 to 5.

In preferred embodiments, the polyether polyol A1b is started on ortho-, meta- or para-toluylenediamine or a mixture of the isomeric toluylenediamines. Particular preference is given to the use of ortho-toluylenediamine as starter. This can be present in the form of a mixture of the 2,3- and 3,4-isomers. In principle, however, the use of other aromatic amines is also conceivable, such as, for example, benzenediamine (all isomers) or methylenediphenyldiamine (all isomers). Preferred epoxides are 1,2-butylene oxide, 2,3-butylene oxide, ethylene oxide and propylene oxide, individually or in mixtures. Particular preference is given to ethylene oxide and propylene oxide, which can be used individually or both together, wherein in the latter case both a random distribution of the oxyalkylene units derived from the ethylene oxide and the propylene oxide and the purposive preparation of block copolymers having a specific structure is conceivable. Particularly preferably, propylene oxide is used on its own or in a mixture with ethylene oxide. In the latter case, the ratio by mass of propylene oxide to ethylene oxide is from 0.25:1 to 4:1, most particularly preferably from 0.5:1 to 2:1. In the case of block copolymers, they are preferably terminated with propylene oxide.

In preferred embodiments, the polycarboxylic acid component used in the preparation of the polyester polyol A1c has from 2 to 36, particularly preferably from 2 to 12 carbon atoms. It most particularly preferably comprises at least one compound selected from the group consisting of:
succinic acid, fumaric acid, maleic acid, maleic anhydride, glutaric acid, adipic acid, sebacic acid, suberic acid, azelaic acid, 1,10-decanedicarboxylic acid, 1,12-dodecanedicarboxylic acid, phthalic acid, phthalic anhydride, isophthalic acid, terephthalic acid, pyromellitic acid and trimellitic acid.

Extremely most particularly preferably, the polycarboxylic acid component A1c consists of phthalic acid and adipic acid or of phthalic anhydride and adipic acid.

Preferred polyalcohol components used in the preparation of the polyester polyol A1c are ethylene glycol and diethylene glycol including their higher homologues, 1,2-propanediol, dipropylene glycol and its higher homologues, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol including their higher homologues, 2-methyl-1,3-propanediol, neopentyl glycol, 3-methyl-L5-pentanediol, glycerol, pentaerythritol, 1,1,1-trimethylolpropane and carbohydrates having from 5 to 12 carbon atoms (such as, for example, isosorbide). Ethylene glycol and diethylene glycol are most particularly preferred.

In each case, it must be ensured when choosing the starting components that the total amount according to the invention of aromatic dicarboxylic acid derivatives used in the esterification is observed.

The esterification (polycondensation) of the polycarboxylic acid component and the polyalcohol component can be carried out according to all methods of the prior art known to the person skilled in the art, provided that the specified requirements as regards the total amount of aromatic dicarboxylic acid derivatives are observed and the polycondensation is carried out with removal of the water that forms to the maximum possible conversion. The latter ensures that the total amount of aromatic dicarboxylic acid derivatives in the reaction mixture of the esterification is a reliable measure of the total amount of esterified aromatic dicarboxylic acid derivatives in A1c. If, in addition to water, readily volatile constituents such as low molecular weight alcohols are also removed unintentionally during the esterification, they are to be so replaced that the desired hydroxyl number is achieved.

In particular embodiments, the polyol mixture A1can also contain further polyols. Thus, there can also be present (iv) a short-chained polyether polyol A1d started on an aliphatic amine or a polyhydric alcohol and having a hydroxyl number of from 500 mg KOH/g to 1000 mg KOH/g, preferably from 600 mg KOH/g to 950 mg KOH/g, particularly preferably from 700 mg KOH/g to 900 mg KOH/g, and a functionality of from 1.5 to 5.0, preferably from 2.0 to 4.5, particularly preferably from 2.5 to 4.0. A1d is particularly preferably obtained by addition of epoxides to ethylenediamine or trimethylolpropane. Preferred epoxides are ethylene oxide and propylene oxide; propylene oxide is particularly preferred.

Furthermore, the polyol mixture A1can also contain (v) a di- to tetra-functional aminic or alcoholic chain extender or crosslinker A1e. A1e is preferably selected from glycerol, butanediol, ethylene glycol, diethylene glycol, propylene glycol, ethylenediamine, ethanolamine, triethanolamine, trimethylolpropane and pentaerythritol.

It is additionally possible to use in the polyol mixture A1 also polyether carbonate polyols A1f, as are obtainable, for example, by catalytic reaction of epoxides and carbon dioxide in the presence of H-functional starter substances (see e.g. EP 2 046 861 A1). These polyether carbonate polyols generally have a functionality of greater than or equal to 1.0, preferably from 2.0 to 8.0, particularly preferably from 2.0 to 7.0 and most particularly preferably from 2.0 to 6.0. The number-average molar mass is preferably from 400 g/mol to 10,000 g/mol and particularly preferably from 500 g/mol to 6000 g/mol.

The number-average molar mass Mₙ is determined within the context of this invention by gel permeation chromatography according to DIN 55672-1 of August 2007.

The physical blowing agent T is not subject to any fundamental limitations, provided that it is not soluble in the polyol mixture A1 under the prevailing marginal conditions (temperature, pressure) (because it would then not be possible to prepare an emulsion). The physical blowing agents to be used according to the invention are preferably selected from hydrocarbons (e.g. n-pentane, isopentane, cyclopentane, butane, isobutane), ethers (e.g. methylal), halogenated ethers, perfluorinated hydrocarbons having from 1 to 8 carbon atoms (e.g. perfluorohexane), as well as mixtures thereof with one another. In particularly preferred embodiments, a pentane isomer or a mixture of various pentane isomers is used as the physical blowing agent T. Cyclopentane is extremely particularly preferably used as the blowing agent T.

In particularly preferred embodiments, the emulsion according to the invention contains in each case exactly one polyol A1a, A1b and A1c and, in each case if present, in each case exactly one polyol A1d, A1e and A1f. It is further preferred for no further polyols to be present apart from A1a, A1b and A1c and, in each case if present, A1d, A1e and A1f, that is to say the polyol mixture A1 consists in preferred embodiments of a maximum of six polyols.

It is generally advantageous if the isocyanate-reactive composition A also contains further components in addition to the polyol mixture comprising A1. Such components are known in principle to the person skilled in the art and include, for example, water, foam stabilisers, catalysts, flame retardants and optionally further auxiliary substances and additives. In particularly preferred embodiments, the isocyanate-reactive composition A additionally comprises
(vi) water A2;
(vii) at least one foam stabiliser A3 selected from the group of the polyether-polydimethylsiloxane copolymers, preferably copolymers that have been functionalised with polyether side chains containing propylene oxide and/or ethylene oxide;

and
(viii) at least one catalyst A4 selected from the group
   triethylenediamine, N,N-dimethylcyclohexylamine, dicyclohexylmethylamine, tetramethylenediamine, 1-methyl-4-dimethylaminoethylpiperazine, triethylamine, tributylamine, dimethylbenzylamine, N,N′,N″-tris-(dimethylaminopropyl)hexahydrotriazine, tris-(di-methylaminopropyl)amine, tris-(dimethylaminomethyl)phenol, dimethylaminopropyl formamide, N,N,N′,N′-tetramethylethylenediamine, N,N,N′,N′-tetramethylbutanediamine, tetramethylhexanediamine, pentamethyldiethylenetriamine, pentamethyldipropylenetriamine, tetramethyldiaminoethyl ether, dimethylpiperazine, 1,2-dimethylimidazole, 1-aza-bicyclo[3.3.0]octane, bis-(dimethylaminopropyl)-urea, N-methylmorpholine, N-ethyl-morpholine, sodium N-[(2-hydroxy-5-nonylphenyl)methyl]-N-methylaminoacetate, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine,
   if necessary (where high polyisocyanurate contents are desired) together with at least one catalyst selected from the group
   tin(II) acetate, tin(II) octoate, tin(II) ethylhexoate, tin(II) laurate, dibutyltin diacetate, dibutyltin dilaurate, dibutyltin maleate, dioctyltin diacetate, tris-(N,N-dimethylaminopropyl)-s-hexahydrotriazine, tetramethylammonium hydroxide, sodium acetate, sodium octoate, potassium acetate, potassium octoate, sodium hydroxide.

The water thereby acts as a chemical co-blowing agent, that is to say reaction with the isocyanate groups releases carbon dioxide, which acts as a blowing agent in addition to T.

For the establishment of a stable emulsion it is additionally advantageous to maintain specific relative proportions of blowing agent T to the polyol mixtures A1. In preferred embodiments the invention thus relates to an emulsion in which the mass ratio of A1:T is preferably ≧5:1 to ≦12:1, more preferably ≧10:1 to ≦5:1, most preferably ≧9:1 to ≦6:1.

In preferred forms of the emulsion according to the invention, the components of the isocyanate-reactive composition A are present in the following amounts by mass, in each case based on the total mass of the isocyanate-reactive composition A:

polyol A1a from 5.0% by mass to 60% by mass, preferably from 15% by mass to 50% by mass,

polyol A1b from 5.0% by mass to 60% by mass, preferably from 10% by mass to 50% by mass,

polyol A1c from 5.0% by mass to 60% by mass, preferably from 15% by mass to 50% by mass,

polyol A1d from 0% by mass to 20% by mass, preferably from 0% by mass to 15% by mass,

polyol A1e from 0% by mass to 20% by mass, preferably from 0% by mass to 15% by mass,

polyol A1f from 0% by mass to 20% by mass, preferably from 0% by mass to 15% by mass,

water A2 from 0% by mass to 5.0% by mass, preferably from 0.5% by mass to 3% by mass,

foam stabiliser A3 from 1.0% by mass to 10% by mass, preferably from 1.5% by mass to 8% by mass,

catalyst A4 from 0.50% by mass to 5.0% by mass, preferably from 1.0% by mass to 4.0% by mass.

The emulsion according to the invention preferably contains the polyol mixture A1 in an amount by mass of from 80% by mass to 90% by mass and the physical blowing agent T in an amount by mass of from 10% by mass to 20% by mass, in each case based on the total mass of the emulsion.

Where a plurality of representatives of a component are present (e.g. a mixture of two physical blowing agents T, Tl and T2), the above-mentioned amounts by mass apply to the sum of the respective representatives of a component (i.e. in the mentioned example of two physical foaming agents T, the sum of the amounts by mass of T1 and T2 in the emulsion is from 10% by mass to 20% by mass).

In particularly preferred embodiments, no further components are present, that is to say the emulsion consists particularly preferably of a maximum of A1a, A1b, A1c, A1d, A1e, A1f; A2, A3, A4 and T. Extremely particularly preferably, the emulsion consists of A1a, A1b, A1c, A2, A3, A4 and T.

The preparation of the emulsions according to the invention is preferably carried out in such a manner that the individual components of the polyol mixture A1 (i.e. at least the polyols A1a, A1b and A1c, optionally further polyols and optionally auxiliary substances and additives as defined above) are mixed in any desired sequence, generally at ambient pressure and temperature, and then the blowing agent T is added to polyol mixture A1.

The emulsions may be prepared by mixing the components for A in arbitrary order, in general at room temperature and ambient pressure and then adding the blowing agent T. The emulsifying may take place using a high shear mixer such as a jet dispergator or a rotor dispergator. Representative examples include those published in Schubert, H. (editor); Emulgiertechnik; R. Behr's Verlag, Hamburg, 2005.

The emulsions according to the invention are distinguished by high stability, without this having to be paid for with an excessively increased viscosity. “Stable” is understood as meaning that the emulsion can be stored at room temperature and normal pressure for at least 1 day, particularly preferably for at least 3 days, most particularly preferably for at least 5 days, without the occurrence of phase separation of the polyol mixture A1 A and the blowing agent T.

The viscosity of the polyol mixture A1 according to the invention at 25° C. of ≧1000 mPas to ≦18000 mPas, particularly preferably ≧1500 mPas to ≦12000 mPas and most particularly preferably ≧2000 mPas to ≦12000 mPas. The viscosity is determined in accordance with EN ISO 3219 in the October 1994 version.

The invention further provides a process for the production of a polyurethane-containing polymer C, in which an isocyanate component B is reacted with an emulsion according to the invention comprising the polyol mixture A1and a physical blowing agent T. The production of polyurethane-containing polymers from isocyanate components and isocyanate-reactive components in the presence of blowing agents and optionally further auxiliary substances and additives is known in principle to the person skilled in the art and has already been described many times. The production of the polyurethane-containing polymers C according to the invention is preferably carried out by processes known to the person skilled in the art. Examples are described in U.S. Pat. No. 2,764,565 and in G. Oertel (ed.) “Kunststoff-Handbuch”, Volume VII, Carl Hanser Verlag, 3rd Edition, Munich 1993, p. 267 to 354 and in K. Uhlig (ed.) “Polyurethan Taschenbuch”, Carl Hanser Verlag, 2nd Edition, Vienna 2001, p. 83 to 102. The foaming of the components to give the polyurethane-containing polymer C can in principle take place in the manner known from the prior art cited by way of example.

In preferred forms of the process according to the invention, the isocyanate component B is
a) at least one isocyanate B1 selected from the group consisting of toluylene diisocyanate, diphenylmethane diisocyanate, polyphenylpolymethylene polyisocyanate (PMDI), xylylene diisocyanate, naphthylene diisocyanate, hexamethylene diisocyanate, diisocyanatodicyclohexylmethane and isophorone diisocyanate
   or
b) an isocyanate-terminated prepolymer B2 prepared from at least one polyisocyanate B1 and at least one isocyanate-reactive compound selected from at least one of the polyols A1a, A1b, A1c, A1d and A1f
   or
c) a mixture of B1 and B2.

The reaction of the isocyanate component B with the emulsion is preferably carried out at indexes of from 95 to 180, preferably from 95 to 150, particularly preferably from 100 to 130. The “index” (also called the isocyanate index) is understood as being the quotient of the quantity [mol] of isocyanate groups actually used and the quantity [mol] of isocyanate groups required stoichiometrically for the complete conversion of all isocyanate-reactive groups, multiplied by 100. Because one mole of an isocyanate group is required to convert one mole of an isocyanate-reactive group, it follows that:

Index=(moles of isocyanate groups/moles of isocyanate reactive groups)·100

The present invention further provides the polyurethane-containing polymers C obtainable by the above-described process according to the invention. Such polyurethane-containing polymers C can be produced by continuous and discontinuous processing methods and are suitable in particular for use as insulating materials.

Polyurethane-containing polymers C produced discontinuously are moulded foams which are preferably delimited by decorative layers on both the top side and the bottom side. Suitable decorative layers are inter alia metals, plastics, wood and paper. Fields of application of such discontinuously produced PUR composite elements which may be mentioned are in particular the commercial insulation of devices such as refrigerators, freezers, fridge-freezers and boilers, refrigerated containers and cool boxes, as well as of pipes.

Continuously produced polyurethane-containing polymers C are continuously produced PUR foam blocks of defined width and variable thickness, which are preferably delimited by decorative layers on both the top side and the bottom side. However, in some fields of application (for example in construction), decorative layers can be omitted completely. Suitable decorative layers are especially metals, metal foils, plastics, wood and paper. Fields of application of such continuously produced PUR composite elements which may be mentioned are in particular the commercial insulation of cold-storage depots and heat insulation in the construction sector.

The use of polyurethane-containing polymers in these fields is known in principle to the person skilled in the art and has already been described many times. The polyurethane-containing polymers C according to the invention are extremely suitable for these purposes because they are distinguished by low coefficients of thermal conductivity, without the fear of processing problems occurring in the production of the foams or their application to suitable substrates (such as, for example, casings of refrigerators or pipes) as a result of excessively high viscosities.

### EXAMPLES

The invention is to be explained in greater detail by means of the following examples.

Substances used
Polyol 1: Polyether polyol having a hydroxyl number of 450 mg KOH/g, a theoretical functionality of 4.7 and a viscosity of 15,000 mPas at 25° C.; Polyol 2:
   Polyether polyol having a hydroxyl number of 460 mg KOH/g, a theoretical functionality of 4.0 and a viscosity of 8000 mPas at 25° C.;
Polyol 3: Aromatic polyester polyol having a hydroxyl number of 235 mg KOH/g, a theoretical functionality of 2.0 and a viscosity of 15,600 mPas at 20° C., prepared by reaction of phthalic anhydride and adipic acid with diethylene glycol and ethylene glycol;
Polyol 4: Aromatic polyester polyol having a hydroxyl number of 210 mg KOH/g, a theoretical functionality of 2.0 and a viscosity of 10,450 mPas at 20° C., prepared by reaction of phthalic anhydride and adipic acid with diethylene glycol;
Polyol 5: Stepanpol PS-2352 having a hydroxyl number of 240 mg KOH/g, a theoretical functionality of 2.0 and a viscosity of 3000 mPas at 20° C. (Stepan); a polyester polyol which meets the requirements according to the invention as regards hydroxyl number and functionality but not as regards the total content of aromatic dicarboxylic acid derivatives.
Polyol 6: Stepanpol PS-3152 having a hydroxyl number of 315 mg KOH/g, a theoretical functionality of 2.0 and a viscosity of 2500 mPas at 20° C. (Stepan);
Tegostab B 8476: Foam stabiliser based on polyether-polydimethylsiloxane copolymers (Evonik).
Desmorapid PV: Amine catalyst (Bayer MaterialScience AG)
Polycat 41: Amine catalyst (Air Products)
Adipic acid: from BASF.
Phthalic anhydride: from Polynt.
Diethylene glycol: from Ineos.
Ethylene glycol: from Ineos.

Performance and Evaluation of the Tests
Hydroxyl numbers (OHZ) were determined according to DIN 53240 (December 1971).
Acid numbers were determined according to DIN EN ISO 2114 (June 2002).
Viscosities were determined according to EN ISO 3219, version of October 1994.
Preparation of the polyols A1c, shown by way of example by means of polyol 4

In an apparatus consisting of a 6-litre 4-necked flask, heating mantle, mechanical stirrer, internal thermometer, 40 cm packed column, column head, descending intensive condenser and membrane vacuum pump, 2003.3 g (18.88 mol) of diethylene glycol, 347.3 g (2.38 mol) of adipic acid and 1637.5 g (9.87 mol) of phthalic anhydride were heated to 200° C., with slow stirring, while being covered with a blanket of nitrogen, whereupon water of reaction distilled off After 5 hours, 35 mg of tin dichloride dihydrate were added and the pressure was reduced continuously over a period of 6 hours to a final value of 15 mbar, and the reaction was completed in the course of a total of 24 hours. The hydroxyl and acid numbers were determined and diethylene glycol lost through distillation was replaced so that the desired hydroxyl number (210 mg KOH/g) was reached, added diethylene glycol being esterified by stirring for 6 hours at 200° C. at normal pressure.

Final Analysis of the Polyester:
Hydroxyl number: 210 mg KOH/g
Acid number: 1.8 mg KOH/g
Viscosity: 10,450 mPas at 20° C.

For reasons of better comparability, the above-mentioned recipe was converted to the substance phthalic acid, hypothetical in this case, by replacing phthalic anhydride with the same amount, in terms of moles, of phthalic acid:

2003.3 g (18.88 mol) of diethylene glycol, 347.3 g (2.38 mol) of adipic acid and 1638.4 g (9.87 mol) of phthalic acid, so that the phthalic acid constitutes an amount in the starting recipe of 1638.4 g, based on the total mixture of 3989.0 g. This corresponds to 41.1% by mass phthalic acid. Because the diethylene glycol lost through distillation is so compensated that the desired hydroxyl number of 210 mg KOH/g was reached, the calculation can be made with the original amount of diethylene glycol matched to that hydroxyl number.

Preparation and Qualitative Assessment of the Emulsions

The polyols were placed in a reaction vessel according to the recipe in question (see table). The required amounts of the additives such as water, catalysts and stabilisers were added individually. Finally, cyclopentane was added as blowing agent and all the components were homogenised for 60 seconds at 4200 rpm using a standard laboratory stirrer.

In order to test the influences on the quality and storage stability of the emulsions, equimolar amounts of polyester polyols (polyols 3 to 6) were used (see table). The amounts of cyclopentane used to prepare the emulsion correspond to the calculated required amount of physical blowing agent that is required to achieve identical densities in a PUR foam produced therewith.

The storage stability was tested under defined conditions. To this end, samples of the freshly prepared emulsion were stored at rest at 19° C. in a closed test tube. At defined intervals (once daily), the quality of the emulsion was determined and documented by visual inspection by specialised personnel. To this end, the degree of cloudiness of the emulsion was estimated visually and a check was made as to whether phase separation had occurred.

The quality of an emulsion was evaluated directly after preparation by measuring the droplet size. To this effect, the emulsion was inspected via an optical microscope using bright field transmission microscopy in a layer thickness of the specimen of 20 μm to 40 μm. The microscope used was an Axioplan 2 microscope from Zeiss. Average droplet sizes of a non-aged emulsion thus determined were below 10 μm.

Results

The following table summarises the results.

TABLE

| Example | | 1 (inv.) | 2 (inv.) | 3 (inv.) | 4 (comp.) |
|---|---|---|---|---|---|
| Polyol 1 | parts by wt. | 50.0 | 50.0 | 50.0 | 50.0 |
| Polyol 2 | parts by wt. | 25.0 | 25.0 | 25.0 | 25.0 |
| Polyol 3 | parts by wt. | 32.3 | 0 | 0 | 0 |
| Polyol 4 | parts by wt. | 0 | 36.9 | 0 | 0 |
| Polyol 5 | parts by wt. | 0 | 0 | 0 | 31.7 |
| Polyol 6 | parts by wt. | 0 | 0 | 24.0 | |
| Water | parts by wt. | 1.5 | 1.5 | 1.5 | 1.5 |
| Tegostab B8476 | parts by wt. | 2.0 | 2.0 | 2.0 | 2.0 |
| Polycat 41 | parts by wt. | 0.5 | 0.5 | 0.5 | 0.5 |
| Desmorapid PV | parts by wt. | 1.0 | 1.0 | 1.0 | 1.0 |
| Cyclopentane | parts by wt. | 15.6 | 16.1 | 14.7 | 13.5 |
| Viscosity [a] | mPa s | 1390 | 1250 | 1010 | 829 |
| Theoretical | | 3.6 | 3.6 | 3.6 | 3.6 |
| functionality [b] | | | | | |
| Phthalic acid in | % by mass | 43.4 | 41.1 | 44.5 | 49.0 |
| the polyol [c] | | | | | |
| Quality after day 1 | qualitative [d] | 1 | 1 | 1 | 5 |
| Quality after day 2 | qualitative [d] | 1 | 1 | 2 | 5 |
| Quality after day 3 | qualitative [d] | 1 | 1 | 2 | 5 |
| Quality after day 6 | qualitative [d] | 2 | 2 | 2 | 5 |
| Phase separation | | 6 | 6 | 6 | 1 |
| on day [e] | | | | | |
| Total storage | days | 5 | 5 | 5 | <1 |
| stability | | | | | |

[a] of the emulsion at 20° C.
[b] of the isocyanate-reactive composition A.
[c] Amount of free phthalic acid used for the polyester polyol synthesis in the reaction mixture (for calculation see synthesis specification polyol 4).
[d] 1 = very good = very cloudy;
2 = good = cloudy;
3 = moderate = not very cloudy;
4 = poor = slightly cloudy;
5 = very poor = clear.
[e] The day after preparation of the emulsion on which phase separation was observed is indicated.

In Examples 1 and 2, phase separation was not observed until the sixth day after preparation of the emulsion. The quality of the polyol emulsion was slightly poorer in Example 3, where the polyester polyol 3 or 4 was replaced in an equimolar manner by the polyester polyol 6. Nevertheless, in this case too, phase separation was only observed after six days. The polyol emulsion used in Example 4, on the other hand, was considerably poorer. Although the polyester polyol 5 used has an OHZ which is very similar to that of polyols 3 and 4, the emulsion from Example 4 was already only very slightly cloudy immediately after its preparation and became clear within the first day. Phase separation was already observed on the day after preparation of the emulsion.

All the examples according to the invention combine the advantages of a storage stability of several days with low viscosities.

1-17. (canceled)

18. An emulsion comprising
(I) an isocyanate-reactive composition A comprising a polyol mixture A1 of at least three polyols A1a, A1b and A1e as the continuous phase
and
(II) at least one physical blowing agent T as the disperse phase,
wherein:
A1a is a polyether polyol having a hydroxyl number of from 15 mg KOH/g to 550 mg KOH/g and having a functionality of from 1.5 to 6.0, obtained by addition of an epoxide to one or more starter compound(s) selected from the group consisting of carbohydrates and di- or higher-functional alcohols;
(ii) A1b is a polyether polyol having a hydroxyl number of from 100 mg KOH/g to 550 mg KOH/g and having a functionality of from 1.5 to 5.0, obtained by addition of an epoxide to an aromatic amine;
(iii) A1e is a polyester polyol having a hydroxyl number of from 100 mg KOH/g to 450 mg KOH/g and having a functionality of from 1.5 to 3.5, obtained by esterification of a polycarboxylic acid component and a polyalcohol component, wherein the total content of aromatic dicarboxylic acid derivatives used in the esterification, calculated on the basis of the free aromatic dicarboxylic acids. is less than or equal to 48.5% by mass, based on the total mass of polyalcohol component and polycarboxylic acid component.

19. The emulsion according to claim 18, wherein the the average size of the droplets of the physical blowing agent T is ≧0.1 μm to ≦20 μm, the droplet size being determined by using an optical microscope operating in bright field transmission mode.

20. The emulsion according to claim 18, wherein the average size of the droplets of the physical blowing agent T is ≧0.1 μm to ≦15 μm, the droplet size being determined by using an optical microscope operating in bright field transmission mode.

21. The emulsion according to claim 18, in which the polyether polyol A1a is a polyether polyol started on sucrose, mixtures of sucrose and propylene glycol, mixtures of sucrose and ethylene glycol, mixtures of sucrose, propylene glycol and ethylene glycol, sorbitol or mixtures of sorbitol and glycerol.

22. The emulsion according to claim 18, in which the polyether polyol A1b is a polyether polyol started on ortho-, meta- or para-toluylenediamine or a mixture of the isomeric toluylenediamines.

23. The emulsion according to claim 18, in which the polyester polyol A1e is a polyester polyol obtained by esterification of
a polycarboxylic acid component selected from the group consisting of
succinic acid, fumaric acid, maleic acid, maleic anhydride, glutaric acid, adipic acid, sebacic acid, suberic acid, azelaic acid, 1,10-decanedicarboxylic acid, 1,12-dodecanedicarboxylic acid, phthalic acid, phthalic anhydride, isophthalic acid, terephthalic acid, pyromellitic acid and trimellitic acid
and
a polyalcohol component selected from the group consisting of
ethylene glycol and diethylene glycol including their higher homologues, 1,2-propanediol, dipropylene glycol and its higher homologues, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol including their higher homologues, 2-methyl-1,3-propanediol, neopentyl glycol, 3-methyl-1,5-pentanediol, glycerol, pentaerythritol, 1,1,1-trimethylolpropane and carbohydrates having from 5 to 12 carbon atoms.

24. The emulsion according to claim 18, in which the polyol mixture A1 additionally comprises:
(iv) a polyether polyol A1d started on an aliphatic amine or a polyhydric alcohol and having a hydroxyl number of from 500 mg KOH/g to 1000 mg KOH/g and a functionality of from 1.5 to 5.0.

25. The emulsion according to claim 18, in which the polyol mixture A1 additionally comprises:
(v) a di- to tetra-functional aminic or alcoholic chain extender or crosslinker.

26. The emulsion according to claim 18, in which the physical blowing agent T is selected from at least one member of the group consisting of
hydrocarbons, halogenated ethers and perfluorinated hydrocarbons having from 1 to 8 carbon atoms.

27. The emulsion according to claim 18, in which the isocyanate-reactive composition A additionally comprises
(vi) water A2;
(vii) at least one stabiliser A3 selected from the group of the polyether-polydimethylsiloxane copolymers;
and
(viii) at least one catalyst A4 selected from the group consisting of
triethylenediamine, N,N-dimethylcyclohexylamine, dicyclohexylmethylamine, tetramethylenediamine, 1-methyl-4-dimethylaminoethylpiperazine, triethylamine, tributylamine, dimethylbenzylamine, N,N′,N″-tris-(dimethylaminopropyl)-hexahydrotriazine, tris-(dimethylaminopropyl)amine, tris-(dimethylaminomethyl)phenol, dimethylaminopropyl formamide, N,N,N′,N′-tetramethylethylenediamine, N,N,N′,N′-tetramethylbutanediamine, tetramethylhexanediamine, pentamethyldiethylenetriamine, pentamethyldipropylenetriamine, tetramethyldiaminoethyl ether, dimethylpiperazine, 1,2-dimethylimidazole, 1-azabicyclo[3.3.0]octane, bis-(dimethylaminopropyl)-urea, N-methylmorpholine, N-ethylmorpholine, sodium N-[(2-hydroxy-5-nonylphenyl)methyl]-N-methylaminoacetate, N-cyclohexylmorpholine, 2,3-dimethyl-3,4,5,6-tetrahydropyrimidine, triethanolamine, diethanolamine, triisopropanolamine, N-methyldiethanolamine, N-ethyl diethanolamine and dimethyl ethanolamine.

28. The emulsion according to claim 18, wherein the mass ratio of A1:T is ≧5:1 to ≦12:1.

29. The emulsion according to claim 18, wherein the polyol component A1 has a viscosity according to EN ISO 3219 at 25° C. of ≧1000 mPas to ≦18000 mPas.

30. A process for the production of a polyurethane-containing polymer C, in which an isocyanate component B is reacted with the emulsion according to claim 18.

31. The process according to claim 30, in which the isocyanate component B is
a) at least one isocyanate B1 selected from the group consisting of
toluylene diisocyanate, diphenylmethane diisocyanate, polyphenylpolymethylene polyisocyanate, xylylene diisocyanate, naphthylene diisocyanate, hexamethylene diisocyanate, diisocyanatodicyclohexylmethane and isophorone diisocyanate
or
b) an isocyanate-terminated prepolymer B2 prepared from at least one polyisocyanate B1 and at least one isocyanate-reactive compound selected from at least one of the following polyols
b1) polyether polyol having a hydroxyl number of from 15 mg KOH/g to 550 mg KOH/g and having a functionality of from 1.5 to 6.0, obtained by addition of an epoxide to one or more starter compound(s) selected from the group consisting of carbohydrates and di- or higher-functional alcohols;
b2) polyether polyol having a hydroxyl number of from 100 mg KOH/g to 550 mg KOH/g and having a functionality of from 1.5 to 5.0, obtained by addition of an epoxide to an aromatic amine (A1b);
b3) polyester polyol having a hydroxyl number of from 100 mg KOH/g to 450 mg KOH/g and having a functionality of from 1.5 to 3.5, obtained by esterification of a polycarboxylic acid component and a polyalcohol component, wherein the total amount of aromatic dicarboxylic acid derivatives used in the esterification, calculated on the basis of the free aromatic dicarboxylic acids, is less than or equal to 48.5% by mass, based on the total mass of polyalcohol component and polycarboxylic acid component (A1c);
b4) polyether polyol having a hydroxyl number of from 500 mg KOH/g to 1000 mg KOH/g and having a functionality of from 1.5 to 5.0 (A1d);
b5) polyether carbonate polyol having a functionality of from >1.0 to 8.0 and a number-average molar mass of from 400 g/mol to 10,000 g/mol (A1f)
or
c) a mixture of B1 and B2.

32. The process according to claim 30, in which the reaction of the isocyanate component B with the emulsion is carried out at indexes of from 95 to 130.

33. A polyurethane-containing polymer C, obtained by a process according to claim 30.

34. A method comprising utilizing the polyurethane-containing polymer C according to claim 33 as insulating material.
